(19) United States
(12) Patent Application Publication
(10) Pub. No.: US 2025/0316078 A1
(43) Pub. Date: Oct. 9, 2025

(54) METHOD, APPARATUS, MEDIUM, AND PRODUCT FOR DYNAMIC MONITORING OF CHANNEL SIDEWALL EXPANSION AND EROSION

(71) Applicant: Beijing Normal University, Beijing (CN)

(72) Inventors: Haifei Liu, Beijing (CN); Ziyi Wang, Beijing (CN); Wei Yang, Beijing (CN)

(21) Appl. No.: 18/895,021

(22) Filed: Sep. 24, 2024

(30) Foreign Application Priority Data
Apr. 8, 2024 (CN) 202410418066.6

(51) Int. Cl. G06V 20/10; G06V 10/77

(52) U.S. Cl. CPC G06V 20/10; G06V 10/77

(57) ABSTRACT

Provided are a method, apparatus, medium, and product for dynamic monitoring of channel sidewall expansion and erosion, relating to the technical field of soil erosion process monitoring. The method includes: inputting an ortho-image temporal sequence into a failure block edge recognition model to obtain a temporal sequence of segmented failure block images, thereby determining spatiotemporal morphological features of a failure block; and inputting the ortho-image temporal sequence into an erosion channel edge recognition model to obtain a temporal sequence of segmented erosion channel sidewall images, thereby determining spatiotemporal morphological features of an erosion channel sidewall. The present application achieves easy operation, low cost, high accuracy, and high automation level in erosion channel development monitoring.

### CROSS REFERENCE TO RELATED APPLICATION

This patent application claims the benefit and priority of Chinese Patent Application No. 2024104180666, filed with the China National Intellectual Property Administration on Apr. 8, 2024, the disclosure of which is incorporated by reference herein in its entirety as part of the present application.

### TECHNICAL FIELD

The present disclosure relates to the technical field of soil erosion process monitoring, and in particular, to a method, apparatus, medium, and product for dynamic monitoring of channel sidewall expansion and erosion.

### BACKGROUND

Measurement of channel morphological parameters for channel erosion usually typically employs a contact monitoring approach, or morphological indices of channels are directly calculated using a tape measure and surface measuring instruments. In recent years, non-contact monitoring technologies for studying channel erosion development have been developed, including satellite remote sensing technology, real-time kinematic positioning (RTK) and light detection and ranging (LiDAR) technology for large-scale monitoring, photogrammetric measurement technology for medium-scale monitoring, and 3D laser scanning technology for small-scale (especially laboratory-scale) monitoring. However, in recognizing morphological changes of channel sidewall expansion and identifying dynamic changes in channel width, the above methods have low automation level and accuracy, and are subjective, limited in the quantity and processing capacity of image data, difficult to operate, and low in spatiotemporal resolution, resulting in the inability to track the spatiotemporal variation characteristics of individual erosion channel sidewalls and failure blocks at a high spatiotemporal resolution baseline, leading to significant uncertainty in channel erosion prediction.

### SUMMARY

Embodiments of the present disclosure is to provide a method, apparatus, medium, and product for dynamic monitoring of channel sidewall expansion and erosion, achieving easy operation, low cost, high accuracy, and high automation level in erosion channel development monitoring.

In at least some aspects, the present disclosure provides the following technical solutions.

A method for dynamic monitoring of channel sidewall expansion and erosion is provided, including:
obtaining an ortho-image temporal sequence of a to-be-monitored area of a to-be-monitored slope;
inputting the ortho-image temporal sequence into a failure block edge recognition model to obtain a temporal sequence of segmented failure block images, where the failure block edge recognition model is obtained by training a Channel-DeepLab model using historical annotated images of failure block edges;
inputting the ortho-image temporal sequence into an erosion channel edge recognition model to obtain a temporal sequence of segmented erosion channel sidewall images, where the erosion channel edge recognition model is obtained by training the Channel-DeepLab model using historical annotated images of erosion channel sidewall edges;
determining spatiotemporal morphological features of a failure block in the to-be-monitored area of the to-be-monitored slope based on the temporal sequence of segmented failure block images; and
determining spatiotemporal morphological features of an erosion channel sidewall in the to-be-monitored area of the to-be-monitored slope based on the temporal sequence of segmented erosion channel sidewall images.

According to specific embodiments provided in the present disclosure, the present disclosure has the following technical effects:

The method, apparatus, medium, and product for dynamic monitoring of channel sidewall expansion and erosion provided by the present disclosure provide technical support for the study of the development mechanism of channel erosion, the study of spatiotemporal changes in channel morphology, as well as soil erosion and control. With the photogrammetric measurement technology, a large amount of image information containing temporal information about the development of channel erosion can be captured rapidly. The present disclosure can obtain a large amount of high-precision image data with low cost, minimal experimental consumables, high automation, and low measurement errors, and accurately capture information about erosion channel sidewalls and failure blocks. Additionally, the Channel-DeepLab network models (channel widening recognition network models) for recognition of channel sidewall expansion and failure blocks are constructed, which can batch process a large number of image resources obtained from photogrammetric measurement, and output morphological features of erosion channel sidewalls and failure blocks with high spatiotemporal resolution, achieving easy operation, low cost, high accuracy, and high automation level.

The present summary is provided only by way of example and not limitation. Other aspects of the present invention will be appreciated in view of the entirety of the present disclosure, including the entire text, claims, and accompanying figures.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a flowchart of a method for dynamic monitoring of channel sidewall expansion and erosion;

FIG. 2 is a principle diagram of a method for dynamic monitoring of channel sidewall expansion and erosion, where 1—Acquisition and preprocessing of high-spatiotemporal-resolution data for erosion channel sidewall expansion process, 2—Establish an erosion channel edge sample dataset, 3—Establish a failure block edge sample dataset, 4—Channel-DeepLab network model for recognition of erosion channel edges and failure block edges, 5—Extraction of high-spatiotemporal-resolution geometric information of erosion channel sidewall and failure block, 6—Acquisition of photogrammetric measurement images 7—Image selection and orthorectification 8—Image cropping, 9—Extract erosion channel edge features 10—Cropping and augmentation of erosion channel images 11—Define erosion channel image training dataset and validation dataset, 12—DeepLabV3+ underlying framework, 13—MobileNetV2 backbone network model, 14—Extract semantic features, 15—Training, evaluation and revision, 16—Extract failure block edge features, 17—Cropping and augmentation of failure block images, 18—Define failure block image training dataset and validation dataset, 19—Weight file for erosion channel edge recognition, 20—Weight file for failure block edge recognition, 21—Segmented erosion channel image, 22—Segmented failure block image, 23—ArcGIS 10.5, and 24—Output geometric information of the water body and failure block, and extract channel widths automatically;

FIG. 3 is a schematic diagram of a laboratory simulation test according to an embodiment of the present disclosure;

FIGS. 4A-4F are diagrams of image pre-processing results with one image in a photogrammetric image library as an example;

FIGS. 5A-5H are diagrams of an example of geometric information extraction results of a channel sidewall and a failure block; and

FIG. 6 is a diagram of an example of a migration trajectory of a specified failure block.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

An objective of the present disclosure is to provide a method, apparatus, medium, and product for dynamic monitoring of channel sidewall expansion and erosion, achieving easy operation, low cost, high accuracy, and high automation level in channel erosion development monitoring.

In order to make the above objective, features and advantages of the present disclosure clearer and more comprehensible, the present disclosure will be further described in detail below in combination with accompanying drawings and particular implementation modes.

### Embodiment 1

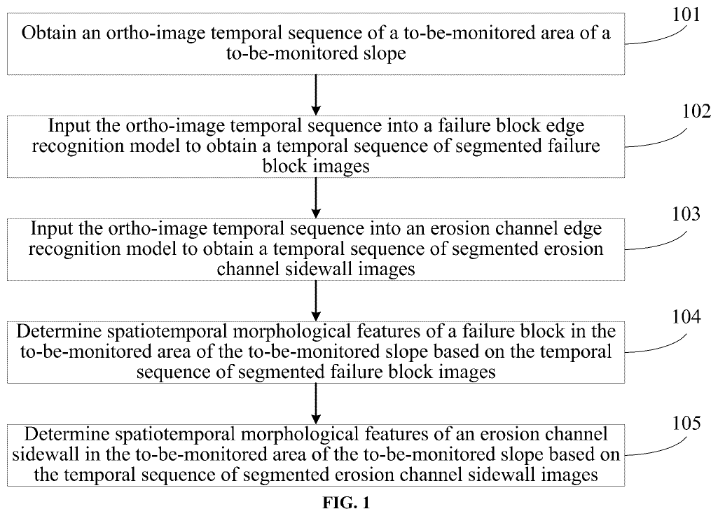

As shown in FIG. 1, a method for dynamic monitoring of channel sidewall expansion and erosion is provided, including the following steps:

Step 101: Obtain an ortho-image temporal sequence of a to-be-monitored area of a to-be-monitored slope.

Step 102: Input the ortho-image temporal sequence into a failure block edge recognition model to obtain a temporal sequence of segmented failure block images. The failure block edge recognition model is obtained by training a Channel-DeepLab model using historical annotated images of failure block edges.

Step 103: Input the ortho-image temporal sequence into an erosion channel edge recognition model to obtain a temporal sequence of segmented erosion channel sidewall images. The erosion channel edge recognition model is obtained by training the Channel-DeepLab model using historical annotated images of channel edge.

Step 104: Determine spatiotemporal morphological features of a failure block in the to-be-monitored area of the to-be-monitored slope based on the temporal sequence of segmented failure block images.

Step 105: Determine spatiotemporal morphological features of an erosion channel sidewall in the to-be-monitored area of the to-be-monitored slope based on the temporal sequence of segmented erosion channel sidewall images.

Step 101 includes the following steps:

Step 1011: Obtain an ortho-image temporal sequence of the to-be-monitored slope.

Step 1012: Determine a rectangular box defined by a plurality of control points within each ortho-image in the ortho-image temporal sequence of the to-be-monitored slope as a cropping box corresponding to the ortho-image.

Step 1013: Crop the ortho-image temporal sequence of the to-be-monitored slope according to the plurality of cropping boxes to obtain the ortho-image temporal sequence of the to-be-monitored area of the to-be-monitored slope.

Before step 101, the method further includes the following steps:

Step 106: Obtain a plurality of historical ortho-images of the to-be-monitored slope.

Step 107: Annotate failure blocks in each historical ortho-image to obtain a plurality of historical annotated images of failure block edges.

Step 108: Determine historical segmented images of failure blocks according to the historical annotated images of failure block edges.

Step 109: Train the Channel-DeepLab model with the historical ortho-images as input and the historical segmented images of failure blocks as output, to obtain the failure block edge recognition model.

Step 1010: Obtain a plurality of historical ortho-images of the to-be-monitored slope.

Step 1011: Annotate erosion channel sidewalls in each historical ortho-image to obtain a plurality of historical annotated images of erosion channel sidewall edges.

Step 1012: Determine historical segmented images of erosion channel sidewalls according to the historical annotated images of erosion channel sidewall edges.

Step 1013: Train the Channel-DeepLab model with the historical ortho-images as input and the historical segmented images of erosion channel sidewalls as output, to obtain the erosion channel edge recognition model.

Step 104 includes the following steps.

Step 1041: Perform binarization processing on the temporal sequence of segmented failure block images using ArcGIS 10.5, to obtain a temporal sequence of binarized failure block images.

Step 1042: Construct an empty set as a spatiotemporal morphological feature set.

Step 1043: Set a time index i=1.

Step 1044: Determine an i-th image in the temporal sequence of binarized failure block images as a current binarized failure block image.

Step 1045: Determine a time point corresponding to the current binarized failure block image as a current temporal feature.

Step 1046: Obtain a plurality of closed regions in the current binarized failure block image as failure block regions.

Step 1047: Determine areas, perimeters, and centroid coordinates of all the failure block regions as a current spatial morphological feature.

Step 1048: Determine the current temporal feature and the current spatial morphological feature as a current spatiotemporal morphological feature.

Step 1049: Add the current spatiotemporal morphological feature as an i-th element to the spatiotemporal morphological feature set, increment a value of the time index i by 1, and return to step 1044 until the temporal sequence of binarized failure block images has been traversed, to obtain the spatiotemporal morphological features of the failure block in the to-be-monitored area of the to-be-monitored slope.

Step 105 includes the following steps.

Step 1051: Perform binarization processing on the temporal sequence of segmented erosion channel sidewall images using ArcGIS 10.5, to obtain a temporal sequence of binarized erosion channel sidewall images.

Step 1052: Construct an empty set as a spatiotemporal morphological feature set.

Step 1053: Set a time index i=1.

Step 1054: Determine an i-th image in the temporal sequence of binarized erosion channel sidewall images as a current binarized erosion channel sidewall image.

Step 1055: Determine a time point corresponding to the current binarized erosion channel sidewall image as a current temporal feature.

Step 1056: Obtain a plurality of closed regions in the current binarized erosion channel sidewall image as erosion channel sidewall regions.

Step 1057: Setting a plurality of straight lines at equal intervals on the current binarized erosion channel sidewall image. The plurality of straight lines are parallel to a Y-axis of an image coordinate system of the current binarized erosion channel sidewall image, and an X-axis of the image coordinate system is parallel to a projection direction of a slope line.

Step 1058: Determine any one of the erosion channel sidewall regions as a current erosion channel sidewall region.

Step 1059: Determine an area and a perimeter of the current erosion channel sidewall region as a first spatial morphological feature.

Step 10510: Determine straight lines that intersect with an edge of the current erosion channel sidewall region as channel width lines.

Step 10511: Determine any one of the channel width lines as a current channel width line.

Step 10512: Determine a horizontal coordinate of the current channel width line as a current channel width position.

Step 10513: Determine that an absolute value of a difference in vertical coordinates of two intersection points of the current channel width line with the edge of the current erosion channel sidewall region is a width of the current erosion channel sidewall region at the current channel width position.

Step 10514: Update the current channel width line and return to step 10511 until all the channel width lines have been traversed, to obtain channel widths of the current erosion channel sidewall region at different current channel width positions as a second spatial morphological feature.

Step 10515: Update the current erosion channel sidewall region and return to step 1059 until all the erosion channel sidewall regions have been traversed, to obtain first spatial morphological features and second spatial morphological features of different erosion channel sidewall regions.

Step 10516: Determine the current temporal feature, as well as the first spatial morphological features and second spatial morphological features of different erosion channel sidewall regions, as the current spatiotemporal morphological feature.

Step 10517: Add the current spatiotemporal morphological feature as an i-th element to the spatiotemporal morphological feature set, increment a value of the time index i by 1, and return to step 1054 until the temporal sequence of binarized erosion channel sidewall images has been traversed, to obtain the spatiotemporal morphological feature of the erosion channel sidewall in the to-be-monitored area of the to-be-monitored slope.

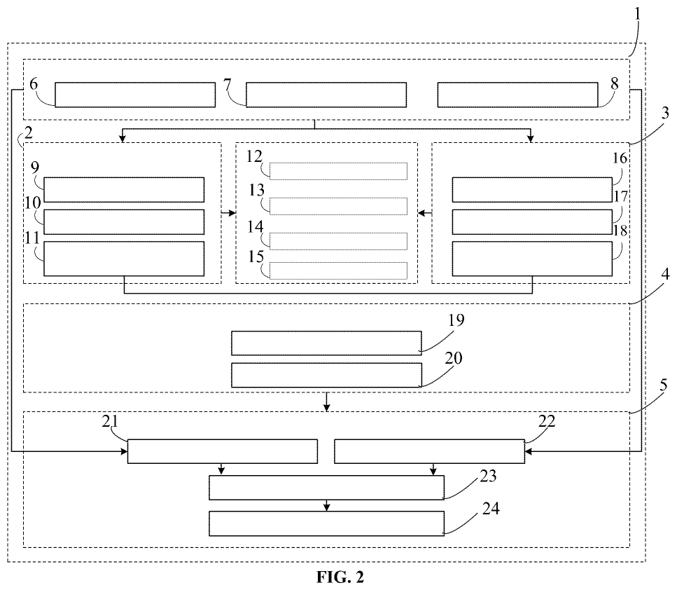

In FIG. 2, 1 represents “Acquisition and preprocessing of high-spatiotemporal-resolution data for erosion channel sidewall expansion process”, 2 represents “Establish an erosion channel edge sample dataset”, 3 represents “Establish a failure block edge sample dataset”, 4 represents “Channel-DeepLab network model for recognition of erosion channel edges and failure block edges”, 5 represents “Extraction of high-spatiotemporal-resolution geometric information of erosion channel sidewall and failure block”, 6 represents “Acquisition of photogrammetric measurement images 7 represents “Image selection and orthorectification 8 represents “Image cropping”, 9 represents “Extract erosion channel edge features 10 represents “Cropping and augmentation of erosion channel images 11 represents “Define erosion channel image training dataset and validation dataset”, 12 represents “DeepLabV3+ underlying framework”, 13 represents “MobileNet V2 backbone network model”, 14 represents “Extract semantic features”, 15 represents “Training”, evaluation and revision “, 16 represents “Extract failure block edge features”, 17 represents “Cropping and augmentation of failure block images”, 18 represents “Define failure block image training dataset and validation dataset”, 19 represents “Weight file for erosion channel edge recognition”, 20 represents “Weight file for failure block edge recognition”, 21 represents “Segmented erosion channel image”, 22 represents “Segmented failure block image”, 23 represents “ArcGIS 10.5”, and 24 represents “Output geometric information of the water body and failure block, and extract channel widths automatically”. The method for dynamic monitoring of channel sidewall expansion and erosion provided by this embodiment is described in detail below. As shown in FIG. 2, this embodiment includes the following processes.

(1) Acquisition of high-spatiotemporal-resolution data for erosion channel sidewall expansion process:

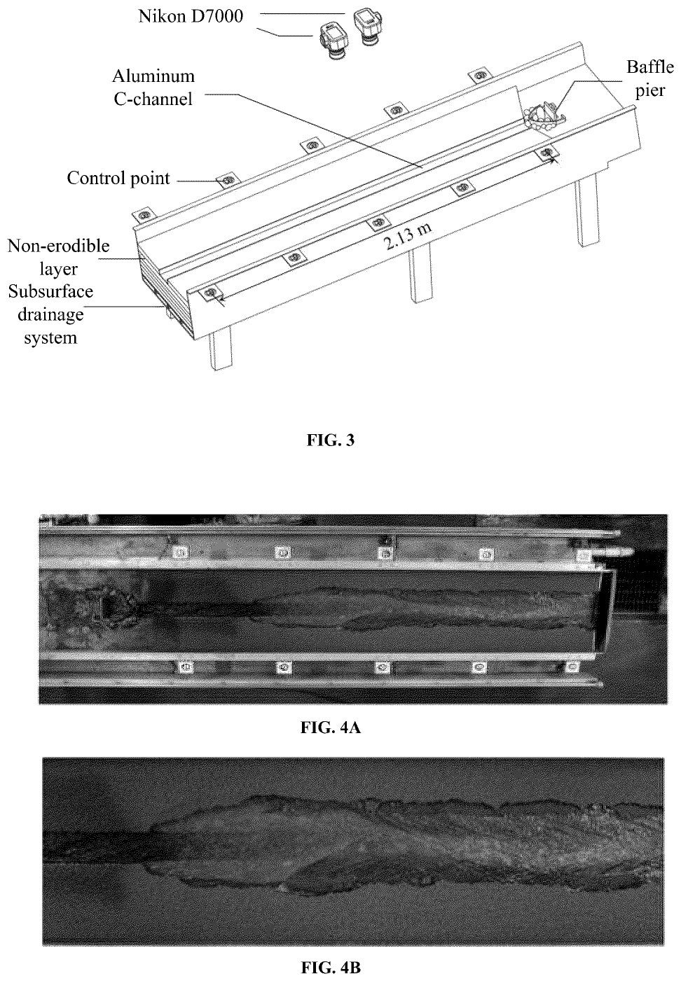

As shown in FIG. 3, the experimental design initially defines that a channel width is 0.1 m, a channel depth is 0.04 m, an upstream runoff flow rate is 0.67 L/s, and a slope gradient is 5%. A downstream, middle, and upstream reaches, and a transition section are defined along the slope length, and the experiment focuses on the erosion and collapse process of the channel sidewall in the downstream, middle, and upstream reaches. The experiment starts when the upstream runoff reaches the outlet of the soil trough, and the experiment ends when the channel sidewall expands to a distance of 0.05 m from the edge of the soil trough. The duration from the start to the end of the experiment is defined as the experiment duration. The experiment duration is divided into three time periods, namely initial, middle, and ending periods of the experiment.

The photogrammetric measurement technology is used to capture changes in channel sidewall expansion as well as the surface areas and positions of failure blocks over time. Specifically, at a slope length of 1.5 m, two Nikon D7000 digital cameras (Nikon Inc, Melville, NY, USA) are installed 3 m above the soil surface on the rain machine bracket (as shown in FIG. 3), ensuring that images captured by the two cameras completely cover the experimental section. Installation angles of the two cameras are adjusted to be parallel to the surface of the soil trough, and an overlap rate of images captured synchronously is above 90%. To ensure normal and stable imaging and the best field of view for the cameras, camera parameters are calibrated before the experiment to adapt to lighting conditions of the laboratory. Ultimately, the aperture is set to f/2.8, ISO is set to 800, the shutter speed is set to 1/60 second, and the focal length is set to 20 mm. Ten control points are evenly distributed on both sides of the soil trough (as shown in FIG. 3) to ensure that the planes where the control points are located are parallel to the soil surface. The relative coordinates of the center of each control point are accurately measured using a total station for generating high-precision ortho-images.

The two cameras are connected to a computer via USB, and with pre-designed computer parameters, including automatic exposure time interval, image information storage path, image storage format, and naming. Both cameras can be controlled to simultaneously and automatically perform image acquisition tasks and store images in the specified path on the computer.

(2) Preprocessing of high-definition images:

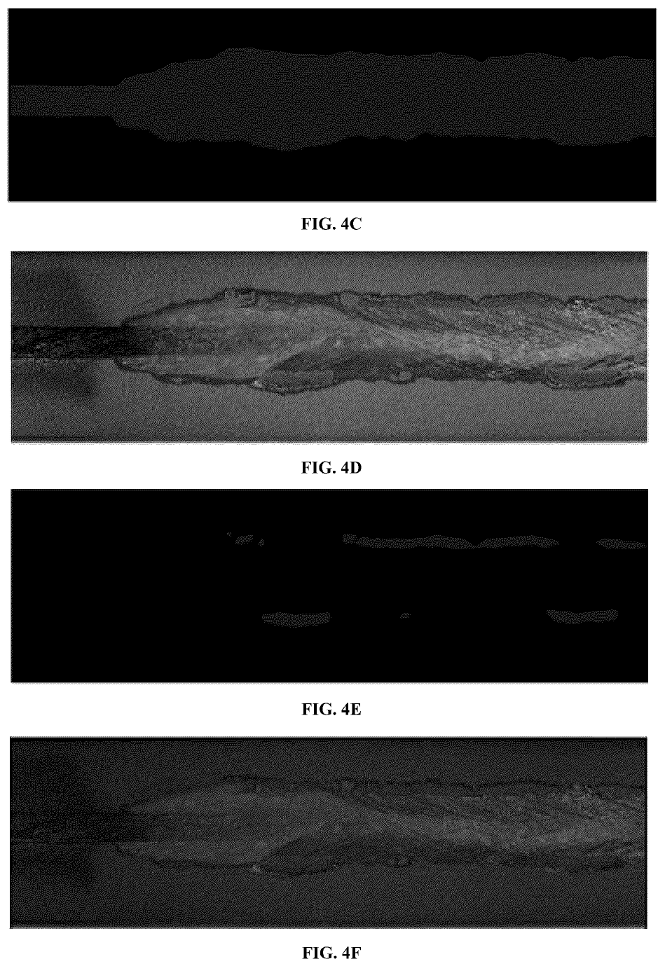

1. Image selection and orthorectification: Images with clear quality from the two cameras, where the control points can be automatically identified by a program, are selected as a data source (as shown in FIG. 4A), and measured coordinates are assigned to the 10 control points. A projection transformation matrix is calculated, and the images are orthorectified to obtain ortho-images. Through resampling, a side length of one pixel in the image represents 1 mm in the actual situation.

2. Image cropping: Intersections of the soil surface with the lines connecting the control point pairs at the upstream and downstream ends of the soil trough are taken as the upper and lower edges for cropping, and the left and right walls of the soil trough are taken as the left and right edges for cropping, and the image is cropped to obtain an ortho-image of the experimental section (as shown in FIG. 4B), with the coordinates of the upper left corner of the cropped ortho-image defined as (0, 0).

(3) Construction of Channel-DeepLab network models for erosion channel sidewall and failure block recognition

1. Annotation of training and validation samples: 60 typical images (including various water edges and failure block types) are selected from the library of the cropped ortho-images, with 40 used for model training and 20 for model validation. The labelme tool package in Matlab is used to annotate the erosion channel sidewall (equivalent to the water surface inside the erosion channel, as shown in FIG. 4F) and the failure block (as shown in FIG. 4D), generating annotated files for program learning.

2. Augmentation of training and validation datasets: To increase the number of training and validation samples for deep learning, reduce computational load, and improve recognition accuracy, each complete ortho-image (annotated file, with an image size of 2141×611) is further randomly cropped into 12 images with an image size 512×512, resulting in 720 annotated files. Rotation, flipping, brightness changes, contrast changes, and other processing are applied to the square images after the secondary cropping, establishing the training and validation datasets for deep learning.

3. Construction of Channel-DeepLab network model: The DeepLab V3+ network model is chosen as the underlying framework, and the MobileNetV2 neural network is used as the backbone model to extract semantic features matching processed images, to build a preliminary Channel-DeepLab network model capable of identifying water body and failure block edges automatically. Based on the Channel-DeepLab network model, edge features of sample images of channel sidewall edges and edge features of sample images of failure block edges are extracted. By utilizing pre-trained weights from MobileNetV2 and employing a frozen training approach, the preliminary model is trained, evaluated, and refined multiple times using sample datasets until the prediction accuracy exceeds 90%, thereby generating a network for channel sidewall and failure block edge recognition, with corresponding weight files for channel sidewall and failure block edge recognition saved. The model is then used to batch process preprocessed images from the erosion channel image library, extracting channel sidewall and failure block surfaces in batches and generating segmented images of the channel sidewall and failure block (as shown in FIG. 4C and FIG. 4E).

(4) Extraction of high-spatiotemporal-resolution geometric information of erosion channel sidewall and failure block:

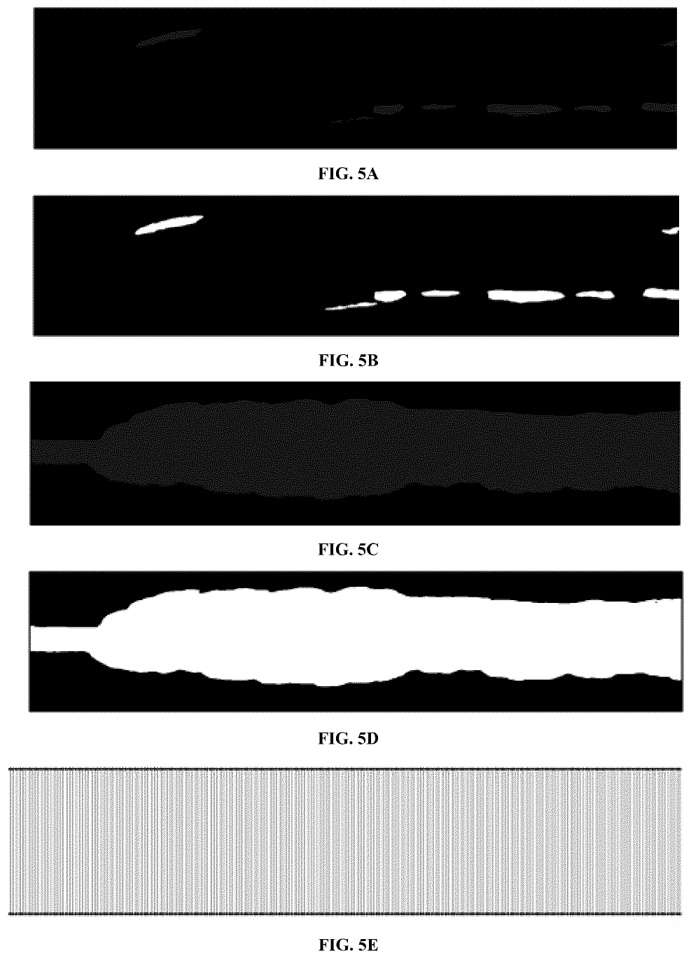

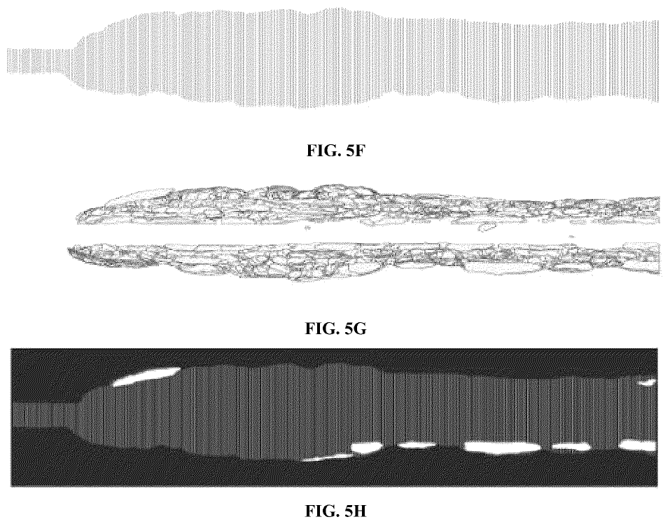

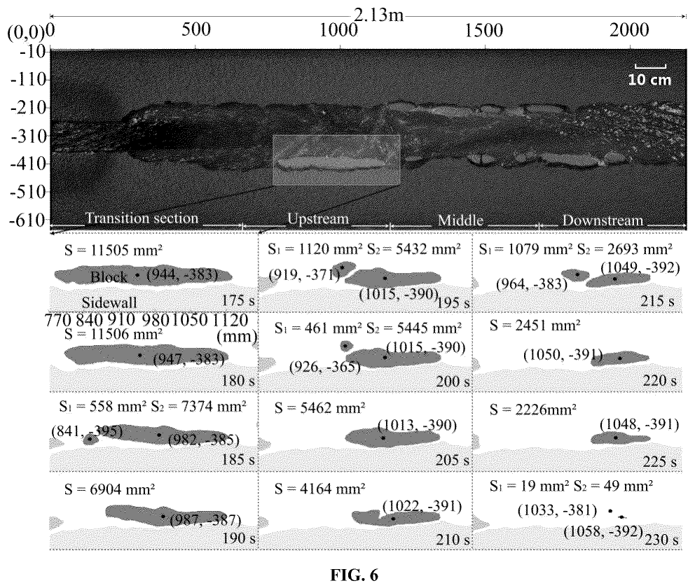

1. Extraction of geometric Information of failure block: The segmented image of the failure block (as shown in FIG. 5A) is imported into ArcGIS 10.5. The segmented image is first binarized (as depicted in FIG. 5B and FIG. 5D) to generate a vector file (as illustrated in FIG. 5G). Fields for index, time, area, perimeter, X and Y coordinates of centroid, and the like are established. Geometric information is calculated and exported, thereby obtaining morphological features of the failure block having temporal and spatial information. Such morphological features can be used for statistical analysis and tracking the migration trajectory of an individual failure block (as shown in FIG. 6).

2. Extraction of geometric information of erosion channel sidewall: The segmented image of the channel sidewall obtained in the previous step (as shown in FIG. 5C) is imported into ArcGIS 10.5. The segmented image is binarized (as shown in FIG. 5D) to generate a vector file. Fields for index, time, area, perimeter, and the like are established, and geometric information is calculated and exported.

3. Extraction of erosion channel width: In ArcGIS 10.5, a set of vertical points are generated at intervals of 1 cm along the slope length, totaling 213 point pairs across the image of the entire study area, which correspond to 213 channel widths (including the transition section). The distance between the two points in each pair is required to be greater than the width of the binarized segmented image. The “PointsToLine” function is used to connect each pair of points into line segments (as shown in FIG. 5E). Subsequently, the line segments are clipped by a vector file of the water surface, resulting in a plurality of line segments of varying lengths for the image of each moment. The length of each line segment represents a channel width value at a specific slope length position at a specific moment (as depicted in parts FIG. 5F and FIG. 5H). The geometric information of line segment lengths is exported for further analysis.

4. Equidistant automatic output of channel widths: The water surface width in this study is equal to the channel width, allowing the extraction of channel widths based on the binarized segmented image of the water body. By matching the pixel point on the left bank of the water body (X1, Y1) with the edge pixel point at the same X coordinate on the right bank (X1, Y2), a pixel point pair is generated. The channel width is then equal to the difference in the Y coordinates of the pixel point pair multiplied by 1 mm. Eventually, corresponding channel widths are output at intervals of 1 mm along the slope length, thereby obtaining channel width feature variations with temporal and spatial information.

### Embodiment 2

A computer apparatus is provided, including a memory, a processor, and a computer program stored in the memory and executable on the processor, where the computer program is executed by the processor to perform the steps of the method for dynamic monitoring of channel sidewall expansion and erosion in Embodiment 1.

### Embodiment 3

A computer-readable storage medium is provided, storing a computer program thereon, where the computer program implements, when executed by a processor, the steps of the method for dynamic monitoring of channel sidewall expansion and erosion in Embodiment 1.

### Embodiment 4

A computer program product is provided, including a computer program, where the computer program, when executed by a processor, implements the steps of the method for dynamic monitoring of channel sidewall expansion and erosion in Embodiment 1.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A method for dynamic monitoring of channel sidewall expansion and erosion, comprising:
obtaining an ortho-image temporal sequence of a to-be-monitored area of a to-be-monitored slope;
inputting the ortho-image temporal sequence into a failure block edge recognition model to obtain a temporal sequence of segmented failure block images, wherein the failure block edge recognition model is obtained by training a Channel-DeepLab model using historical annotated images of failure block edges;
inputting the ortho-image temporal sequence into an erosion channel edge recognition model to obtain a temporal sequence of segmented erosion channel sidewall images, wherein the erosion channel edge recognition model is obtained by training the Channel-DeepLab model using historical annotated images of erosion channel sidewall edges;
determining spatiotemporal morphological features of a failure block in the to-be-monitored area of the to-be-monitored slope based on the temporal sequence of segmented failure block images; and
determining spatiotemporal morphological features of an erosion channel sidewall in the to-be-monitored area of the to-be-monitored slope based on the temporal sequence of segmented erosion channel sidewall images.

2. The method for dynamic monitoring of channel sidewall expansion and erosion according to claim 1, wherein said obtaining the ortho-image temporal sequence of the to-be-monitored area of the to-be-monitored slope comprises:
obtaining an ortho-image temporal sequence of the to-be-monitored slope;
determining a rectangular box defined by a plurality of control points within each ortho-image in the ortho-image temporal sequence of the to-be-monitored slope as a cropping box corresponding to the ortho-image; and
cropping the ortho-image temporal sequence of the to-be-monitored slope according to the plurality of cropping boxes to obtain the ortho-image temporal sequence of the to-be-monitored area of the to-be-monitored slope.

3. The method for dynamic monitoring of channel sidewall expansion and erosion according to claim 1, wherein before obtaining the ortho-image temporal sequence of the to-be-monitored area of the to-be-monitored slope, the method further comprises:
obtaining a plurality of historical ortho-images of the to-be-monitored slope;
annotating failure blocks in each historical ortho-image to obtain a plurality of historical annotated images of failure block edges;
determining historical segmented images of failure blocks according to the historical annotated images of failure block edges; and
training the Channel-DeepLab model with the historical ortho-images as input and the historical segmented images of failure blocks as output, to obtain the failure block edge recognition model.

4. The method for dynamic monitoring of channel sidewall expansion and erosion according to claim 1, wherein before obtaining the ortho-image temporal sequence of the to-be-monitored area of the to-be-monitored slope, the method further comprises:
obtaining a plurality of historical ortho-images of the to-be-monitored slope;
annotating erosion channel sidewalls in each historical ortho-image to obtain a plurality of historical annotated images of erosion channel sidewall edges;
determining historical segmented images of erosion channel sidewalls according to the historical annotated images of erosion channel sidewall edges; and
training the Channel-DeepLab model with the historical ortho-images as input and the historical segmented images of erosion channel sidewalls as output, to obtain the erosion channel edge recognition model.

5. The method for dynamic monitoring of channel sidewall expansion and erosion according to claim 1, wherein said determining the spatiotemporal morphological features of the failure block in the to-be-monitored area of the to-be-monitored slope based on the temporal sequence of segmented failure block images comprises:
performing binarization processing on the temporal sequence of segmented failure block images using ArcGIS 10.5, to obtain a temporal sequence of binarized failure block images;
constructing an empty set as a spatiotemporal morphological feature set;
setting a time index i=1;
determining an i-th image in the temporal sequence of binarized failure block images as a current binarized failure block image;
determining a time point corresponding to the current binarized failure block image as a current temporal feature;
obtaining a plurality of closed regions in the current binarized failure block image as failure block regions;
determining areas, perimeters, and centroid coordinates of all the failure block regions as a current spatial morphological feature;
determining the current temporal feature and the current spatial morphological feature as a current spatiotemporal morphological feature; and
adding the current spatiotemporal morphological feature as an i-th element to the spatiotemporal morphological feature set, incrementing a value of the time index i by 1, and returning to the step of “determining an i-th image in the temporal sequence of binarized failure block images as a current binarized failure block image” until the temporal sequence of binarized failure block images has been traversed, to obtain the spatiotemporal morphological features of the failure block in the to-be-monitored area of the to-be-monitored slope.

6. The method for dynamic monitoring of channel sidewall expansion and erosion according to claim 1, wherein said determining the spatiotemporal morphological features of the erosion channel sidewall in the to-be-monitored area of the to-be-monitored slope based on the temporal sequence of segmented erosion channel sidewall images comprises:
performing binarization processing on the temporal sequence of segmented erosion channel sidewall images using ArcGIS 10.5, to obtain a temporal sequence of binarized erosion channel sidewall images;
constructing an empty set as a spatiotemporal morphological feature set;
setting a time index i=1;
determining an i-th image in the temporal sequence of binarized erosion channel sidewall images as a current binarized erosion channel sidewall image;
determining a time point corresponding to the current binarized erosion channel sidewall image as a current temporal feature;
obtaining a plurality of closed regions in the current binarized erosion channel sidewall image as erosion channel sidewall regions;
setting a plurality of straight lines at equal intervals on the current binarized erosion channel sidewall image, wherein the plurality of straight lines are parallel to a Y-axis of an image coordinate system of the current binarized erosion channel sidewall image, and an X-axis of the image coordinate system is parallel to a projection direction of a slope line;
determining any one of the erosion channel sidewall regions as a current erosion channel sidewall region;
determining an area and a perimeter of the current erosion channel sidewall region as a first spatial morphological feature;
determining straight lines that intersect with an edge of the current erosion channel sidewall region as channel width lines;
determining any one of the channel width lines as a current channel width line;
determining a horizontal coordinate of the current channel width line as a current channel width position;
determining that an absolute value of a difference in vertical coordinates of two intersection points of the current channel width line with the edge of the current erosion channel sidewall region is a width of the current erosion channel sidewall region at the current channel width position;
updating the current channel width line and returning to the step of “determining a horizontal coordinate of the current channel width line as a current channel width position” until all the channel width lines have been traversed, to obtain channel widths of the current erosion channel sidewall region at different current channel width positions as a second spatial morphological feature;
updating the current erosion channel sidewall region and returning to the step of “determining an area and a perimeter of the current erosion channel sidewall region as a first spatial morphological feature” until all the erosion channel sidewall regions have been traversed, to obtain first spatial morphological features and second spatial morphological features of different erosion channel sidewall regions;
determining the current temporal feature, as well as the first spatial morphological features and the second spatial morphological features of different erosion channel sidewall regions, as the current spatiotemporal morphological feature; and
adding the current spatiotemporal morphological feature as an i-th element to the spatiotemporal morphological feature set, incrementing a value of the time index i by 1, and returning to the step of “determining an i-th image in the temporal sequence of binarized erosion channel sidewall images as a current binarized erosion channel sidewall image” until the temporal sequence of binarized erosion channel sidewall images has been traversed, to obtain the spatiotemporal morphological feature of the erosion channel sidewall in the to-be-monitored area of the to-be-monitored slope.

7. A computer apparatus, comprising a memory, a processor, and a computer program stored in the memory and executable on the processor, wherein the computer program is executed by the processor to perform the method for dynamic monitoring of channel sidewall expansion and erosion according to claim 1.

8. The computer apparatus according to claim 7, wherein said obtaining the ortho-image temporal sequence of the to-be-monitored area of the to-be-monitored slope comprises:
obtaining an ortho-image temporal sequence of the to-be-monitored slope;
determining a rectangular box defined by a plurality of control points within each ortho-image in the ortho-image temporal sequence of the to-be-monitored slope as a cropping box corresponding to the ortho-image; and
cropping the ortho-image temporal sequence of the to-be-monitored slope according to the plurality of cropping boxes to obtain the ortho-image temporal sequence of the to-be-monitored area of the to-be-monitored slope.

9. The computer apparatus according to claim 7, wherein before obtaining the ortho-image temporal sequence of the to-be-monitored area of the to-be-monitored slope, the method further comprises:
obtaining a plurality of historical ortho-images of the to-be-monitored slope;
annotating failure blocks in each historical ortho-image to obtain a plurality of historical annotated images of failure block edges;
determining historical segmented images of failure blocks according to the historical annotated images of failure block edges; and
training the Channel-DeepLab model with the historical ortho-images as input and the historical segmented images of failure blocks as output, to obtain the failure block edge recognition model.

10. The computer apparatus according to claim 7, wherein before obtaining the ortho-image temporal sequence of the to-be-monitored area of the to-be-monitored slope, the method further comprises:
obtaining a plurality of historical ortho-images of the to-be-monitored slope;
annotating erosion channel sidewalls in each historical ortho-image to obtain a plurality of historical annotated images of erosion channel sidewall edges;
determining historical segmented images of erosion channel sidewalls according to the historical annotated images of erosion channel sidewall edges; and
training the Channel-DeepLab model with the historical ortho-images as input and the historical segmented images of erosion channel sidewalls as output, to obtain the erosion channel edge recognition model.

11. The computer apparatus according to claim 7, wherein said determining the spatiotemporal morphological features of the failure block in the to-be-monitored area of the to-be-monitored slope based on the temporal sequence of segmented failure block images comprises:
performing binarization processing on the temporal sequence of segmented failure block images using ArcGIS 10.5, to obtain a temporal sequence of binarized failure block images;
constructing an empty set as a spatiotemporal morphological feature set;
setting a time index i=1;
determining an i-th image in the temporal sequence of binarized failure block images as a current binarized failure block image;
determining a time point corresponding to the current binarized failure block image as a current temporal feature;
obtaining a plurality of closed regions in the current binarized failure block image as failure block regions;
determining areas, perimeters, and centroid coordinates of all the failure block regions as a current spatial morphological feature;
determining the current temporal feature and the current spatial morphological feature as a current spatiotemporal morphological feature; and
adding the current spatiotemporal morphological feature as an i-th element to the spatiotemporal morphological feature set, incrementing a value of the time index i by 1, and returning to the step of “determining an i-th image in the temporal sequence of binarized failure block images as a current binarized failure block image” until the temporal sequence of binarized failure block images has been traversed, to obtain the spatiotemporal morphological features of the failure block in the to-be-monitored area of the to-be-monitored slope.

12. The computer apparatus according to claim 7, wherein said determining the spatiotemporal morphological features of the erosion channel sidewall in the to-be-monitored area of the to-be-monitored slope based on the temporal sequence of segmented erosion channel sidewall images comprises:
performing binarization processing on the temporal sequence of segmented erosion channel sidewall images using ArcGIS 10.5, to obtain a temporal sequence of binarized erosion channel sidewall images;
constructing an empty set as a spatiotemporal morphological feature set;
setting a time index i=1;
determining an i-th image in the temporal sequence of binarized erosion channel sidewall images as a current binarized erosion channel sidewall image;
determining a time point corresponding to the current binarized erosion channel sidewall image as a current temporal feature;
obtaining a plurality of closed regions in the current binarized erosion channel sidewall image as erosion channel sidewall regions;
setting a plurality of straight lines at equal intervals on the current binarized erosion channel sidewall image, wherein the plurality of straight lines are parallel to a Y-axis of an image coordinate system of the current binarized erosion channel sidewall image, and an X-axis of the image coordinate system is parallel to a projection direction of a slope line;
determining any one of the erosion channel sidewall regions as a current erosion channel sidewall region;
determining an area and a perimeter of the current erosion channel sidewall region as a first spatial morphological feature;
determining straight lines that intersect with an edge of the current erosion channel sidewall region as channel width lines;
determining any one of the channel width lines as a current channel width line;
determining a horizontal coordinate of the current channel width line as a current channel width position;
determining that an absolute value of a difference in vertical coordinates of two intersection points of the current channel width line with the edge of the current erosion channel sidewall region is a width of the current erosion channel sidewall region at the current channel width position;
updating the current channel width line and returning to the step of “determining a horizontal coordinate of the current channel width line as a current channel width position” until all the channel width lines have been traversed, to obtain channel widths of the current erosion channel sidewall region at different current channel width positions as a second spatial morphological feature;
updating the current erosion channel sidewall region and returning to the step of “determining an area and a perimeter of the current erosion channel sidewall region as a first spatial morphological feature” until all the erosion channel sidewall regions have been traversed, to obtain first spatial morphological features and second spatial morphological features of different erosion channel sidewall regions;
determining the current temporal feature, as well as the first spatial morphological features and the second spatial morphological features of different erosion channel sidewall regions, as the current spatiotemporal morphological feature; and
adding the current spatiotemporal morphological feature as an i-th element to the spatiotemporal morphological feature set, incrementing a value of the time index i by 1, and returning to the step of “determining an i-th image in the temporal sequence of binarized erosion channel sidewall images as a current binarized erosion channel sidewall image” until the temporal sequence of binarized erosion channel sidewall images has been traversed, to obtain the spatiotemporal morphological feature of the erosion channel sidewall in the to-be-monitored area of the to-be-monitored slope.

13. A computer-readable storage medium, storing a computer program in a non-transitory computer-readable form, wherein the computer program is executable by at least one processor to implement the method for dynamic monitoring of channel sidewall expansion and erosion according to claim 1.

14. The computer-readable storage medium according to claim 13, wherein said obtaining the ortho-image temporal sequence of the to-be-monitored area of the to-be-monitored slope comprises:
obtaining an ortho-image temporal sequence of the to-be-monitored slope;
determining a rectangular box defined by a plurality of control points within each ortho-image in the ortho-image temporal sequence of the to-be-monitored slope as a cropping box corresponding to the ortho-image; and
cropping the ortho-image temporal sequence of the to-be-monitored slope according to the plurality of cropping boxes to obtain the ortho-image temporal sequence of the to-be-monitored area of the to-be-monitored slope.

15. The computer-readable storage medium according to claim 13, wherein before obtaining the ortho-image temporal sequence of the to-be-monitored area of the to-be-monitored slope, the method further comprises:
obtaining a plurality of historical ortho-images of the to-be-monitored slope;
annotating failure blocks in each historical ortho-image to obtain a plurality of historical annotated images of failure block edges;
determining historical segmented images of failure blocks according to the historical annotated images of failure block edges; and
training the Channel-DeepLab model with the historical ortho-images as input and the historical segmented images of failure blocks as output, to obtain the failure block edge recognition model.

16. The computer-readable storage medium according to claim 13, wherein before obtaining the ortho-image temporal sequence of the to-be-monitored area of the to-be-monitored slope, the method further comprises:
obtaining a plurality of historical ortho-images of the to-be-monitored slope;
annotating erosion channel sidewalls in each historical ortho-image to obtain a plurality of historical annotated images of erosion channel sidewall edges;
determining historical segmented images of erosion channel sidewalls according to the historical annotated images of erosion channel sidewall edges; and
training the Channel-DeepLab model with the historical ortho-images as input and the historical segmented images of erosion channel sidewalls as output, to obtain the erosion channel edge recognition model.

17. The computer-readable storage medium according to claim 13, wherein said determining the spatiotemporal morphological features of the failure block in the to-be-monitored area of the to-be-monitored slope based on the temporal sequence of segmented failure block images comprises:
performing binarization processing on the temporal sequence of segmented failure block images using ArcGIS 10.5, to obtain a temporal sequence of binarized failure block images;
constructing an empty set as a spatiotemporal morphological feature set;
setting a time index i=1;
determining an i-th image in the temporal sequence of binarized failure block images as a current binarized failure block image;
determining a time point corresponding to the current binarized failure block image as a current temporal feature;
obtaining a plurality of closed regions in the current binarized failure block image as failure block regions;
determining areas, perimeters, and centroid coordinates of all the failure block regions as a current spatial morphological feature;
determining the current temporal feature and the current spatial morphological feature as a current spatiotemporal morphological feature; and
adding the current spatiotemporal morphological feature as an i-th element to the spatiotemporal morphological feature set, incrementing a value of the time index i by 1, and returning to the step of “determining an i-th image in the temporal sequence of binarized failure block images as a current binarized failure block image” until the temporal sequence of binarized failure block images has been traversed, to obtain the spatiotemporal morphological features of the failure block in the to-be-monitored area of the to-be-monitored slope.

18. The computer-readable storage medium according to claim 13, wherein said determining the spatiotemporal morphological features of the erosion channel sidewall in the to-be-monitored area of the to-be-monitored slope based on the temporal sequence of segmented erosion channel sidewall images comprises:
performing binarization processing on the temporal sequence of segmented erosion channel sidewall images using ArcGIS 10.5, to obtain a temporal sequence of binarized erosion channel sidewall images;
constructing an empty set as a spatiotemporal morphological feature set;
setting a time index i=1;
determining an i-th image in the temporal sequence of binarized erosion channel sidewall images as a current binarized erosion channel sidewall image;
determining a time point corresponding to the current binarized erosion channel sidewall image as a current temporal feature;
obtaining a plurality of closed regions in the current binarized erosion channel sidewall image as erosion channel sidewall regions;
setting a plurality of straight lines at equal intervals on the current binarized erosion channel sidewall image, wherein the plurality of straight lines are parallel to a Y-axis of an image coordinate system of the current binarized erosion channel sidewall image, and an X-axis of the image coordinate system is parallel to a projection direction of a slope line;
determining any one of the erosion channel sidewall regions as a current erosion channel sidewall region;
determining an area and a perimeter of the current erosion channel sidewall region as a first spatial morphological feature;
determining straight lines that intersect with an edge of the current erosion channel sidewall region as channel width lines;
determining any one of the channel width lines as a current channel width line;
determining a horizontal coordinate of the current channel width line as a current channel width position;
determining that an absolute value of a difference in vertical coordinates of two intersection points of the current channel width line with the edge of the current erosion channel sidewall region is a width of the current erosion channel sidewall region at the current channel width position;
updating the current channel width line and returning to the step of “determining a horizontal coordinate of the current channel width line as a current channel width position” until all the channel width lines have been traversed, to obtain channel widths of the current erosion channel sidewall region at different current channel width positions as a second spatial morphological feature;
updating the current erosion channel sidewall region and returning to the step of “determining an area and a perimeter of the current erosion channel sidewall region as a first spatial morphological feature” until all the erosion channel sidewall regions have been traversed, to obtain first spatial morphological features and second spatial morphological features of different erosion channel sidewall regions;
determining the current temporal feature, as well as the first spatial morphological features and the second spatial morphological features of different erosion channel sidewall regions, as the current spatiotemporal morphological feature; and
adding the current spatiotemporal morphological feature as an i-th element to the spatiotemporal morphological feature set, incrementing a value of the time index i by 1, and returning to the step of “determining an i-th image in the temporal sequence of binarized erosion channel sidewall images as a current binarized erosion channel sidewall image” until the temporal sequence of binarized erosion channel sidewall images has been traversed, to obtain the spatiotemporal morphological feature of the erosion channel sidewall in the to-be-monitored area of the to-be-monitored slope.

19. A computer program product, comprising a computer program stored in a non-transitory computer-readable storage medium, wherein the computer program, when executed by at least one processor, implements the method for dynamic monitoring of channel sidewall expansion and erosion according to claim 1.

20. The computer program product according to claim 19, wherein said obtaining the ortho-image temporal sequence of the to-be-monitored area of the to-be-monitored slope comprises:
obtaining an ortho-image temporal sequence of the to-be-monitored slope;
determining a rectangular box defined by a plurality of control points within each ortho-image in the ortho-image temporal sequence of the to-be-monitored slope as a cropping box corresponding to the ortho-image; and
cropping the ortho-image temporal sequence of the to-be-monitored slope according to the plurality of cropping boxes to obtain the ortho-image temporal sequence of the to-be-monitored area of the to-be-monitored slope.
